(19) United States
(12) Patent Application Publication
(10) Pub. No.: US 2026/0333142 A1
(43) Pub. Date: Oct. 22, 2026

(54) PSCELL CHANGE OPTIMIZATION METHOD AND DEVICE

(71) Applicant: CHINA TELECOM CORPORATION LIMITED, Beijing (CN)

(72) Inventors: Shengnan LIU, Beijing (CN); Zheng JIANG, Beijing (CN); Xiaoming SHE, Beijing (CN)

(21) Appl. No.: 19/110,412

(22) PCT Filed: Jul. 26, 2023
(86) PCT No.: PCT/CN2023/109358

§ 371 Date: Mar. 10, 2025

(30) Foreign Application Priority Data
Sep. 8, 2022 (CN) 202211093731.6

(51) Int. Cl. H04W 36/00

(52) U.S. Cl. CPC H04W 36/0058; H04W 36/0069

(57) ABSTRACT

The present disclosure relates to a PSCell change optimization method applied to a first network node, including: sending first signaling to a terminal, the first signaling indicating the terminal to report a successful PSCell change report; and receiving the successful PSCell change report sent by the terminal via second signaling, the successful PSCell change report being configured to optimize a PSCell change configuration.

### CROSS-REFERENCE TO RELATED APPLICATIONS

The present application is a national phase of International Application No. PCT/CN 2023/109358, filed on Jul. 26, 2023, which claims the benefit of and priority to Chinese Patent Application No. 2022110937316, entitled “Primary Secondary Cell Change Optimization Method, Device, Apparatus, Medium And Program Product”, filed on Sep. 8, 2022, the contents of both of which being incorporated by reference in their entireties herein.

### TECHNICAL FIELD

The present disclosure relates to the field of wireless communication technology and, in particular, to a primary secondary cell (PSCell) change optimization method, device, apparatus, medium and program product.

### BACKGROUND

Mobility robustness optimization (MRO) relates to the detection and correction of mobility-related problems, including unnecessary inter-system handover, inter-system ping-pong handover, and connection failures due to intra-or inter-system mobility.

In the related art, MRO for primary secondary cell (PSCell) change scenarios is ineffective and thus requires further optimization.

It is to be noted that the above information disclosed in the Background section is only for enhancement of understanding of the background of the present disclosure and therefore it may contain information that does not form the prior art that is already known to a person skilled in the art.

### BRIEF SUMMARY

The present disclosure provides a primary secondary cell (PSCell) change optimization method, device, apparatus, medium and program product.

In an embodiment, the explanations of terms in the present disclosure may refer to the definitions in 3 GPP TS38 series.

A first aspect of the present disclosure provides a PSCell change optimization method applied to a first network node, including:
sending first signaling to a terminal, the first signaling indicating the terminal to report a successful PSCell change report; and
receiving the successful PSCell change report sent by the terminal via second signaling, the successful PSCell change report being configured to optimize a PSCell change configuration.

A second aspect of the present disclosure provides a PSCell change optimization method applied to a terminal, including:
receiving first signaling sent by a first network node, the first signaling indicating the terminal to report a successful PSCell change report; and
reporting, via second signaling, the successful PSCell change report to the first network node, the successful PSCell change report being configured to optimize a PSCell change configuration.

A third aspect of the present disclosure provides a PSCell change optimization device applied to a first network node, including:
a signaling sending module, configured to send first signaling to a terminal, the first signaling indicating the terminal to report a successful PSCell change report; and
a first receiving module, configured to receive the successful PSCell change report sent by the terminal via second signaling, the successful PSCell change report being configured to optimize a PSCell change configuration.

A fourth aspect of the present disclosure provides a PSCell change optimization device applied to a terminal, including:
a second receiving module, configured to receive first signaling sent by a first network node, the first signaling indicating the terminal to report a successful PSCell change report; and
an information reporting module, configured to report, via second signaling, the successful PSCell change report to the first network node, the successful PSCell change report being configured to optimize a PSCell change configuration.

A fifth aspect of the present disclosure provides an electronic device, including: a memory, configured to store instructions; and a processor, configured to invoke the instructions stored in the memory to implement the PSCell change optimization method described above.

A sixth aspect of the present disclosure provides a computer-readable storage medium having stored thereon computer instructions, and the computer instructions, when executed by the processor, implement the PSCell change optimization method described above.

A seventh aspect of the present disclosure provides a computer program product storing instructions that, when being executed by a computer, cause the computer to implement the PSCell change optimization method described above.

An eighth aspect of the present disclosure provides a chip including at least one processor and an interface,
the interface is configured to provide program instructions or data to the at least one processor, and
the at least one processor is configured to execute the program instructions to implement the PSCell change optimization method described above.

It should be understood that the above general description and the detailed description that follows are exemplary and explanatory only and do not limit the present disclosure.

### BRIEF DESCRIPTION OF THE DRAWINGS

The accompanying drawings herein are incorporated into and form a part of the specification, illustrate embodiments consistent with the present disclosure, and are used in conjunction with the specification to explain the principle of the present disclosure.

Understandably, the accompanying drawings in the following description are only some of the embodiments of the present disclosure, and other accompanying drawings may be obtained from these drawings by a person skilled in the art without creative labor.

FIG. 1 illustrates a schematic diagram of an MR-DC architecture in an embodiment of the present disclosure;

FIG. 2 illustrates a schematic diagram of another MR-DC architecture in an embodiment of the present disclosure;

FIG. 3 illustrates a flowchart of a PSCell change optimization method in an embodiment of the present disclosure;

FIG. 4 illustrates a flowchart of another PSCell change optimization method in an embodiment of the present disclosure;

FIG. 5 illustrates a flowchart of yet another PSCell change optimization method in an embodiment of the present disclosure;

FIG. 6 illustrates a flowchart of further another PSCell change optimization method in an embodiment of the present disclosure;

FIG. 7 illustrates a flowchart of a PSCell change optimization method applied to a first network node in an embodiment of the present disclosure;

FIG. 8 illustrates a flowchart of a PSCell change optimization method applied to a terminal in an embodiment of the present disclosure;

FIG. 9 illustrates a schematic diagram of a PSCell change optimization device in an embodiment of the present disclosure;

FIG. 10 illustrates a schematic diagram of a PSCell change optimization device in an embodiment of the present disclosure;

FIG. 11 illustrates a block diagram of a structure of an electronic device in an embodiment of the present disclosure.

### DETAILED DESCRIPTION

Example implementations will be described more fully below with reference to the accompanying drawings.

It is to be noted that the example implementations may be implemented in a variety of forms and should not be construed as being limited to the examples set forth herein.

The 3GPP introduced multi-radio dual connectivity (MR-DC) in the stage R12, which enables traffic offloading between base stations via X2/Xn interfaces to improve the spectrum utilization and coverage capacity of the network. This technology is also widely used in 4G and 5G coexistence scenario, and the MR-DC has become one of the key technologies under the 5G multi-network convergence architecture.

With the development of millimeter wave technology or the like, the MR-DC architecture is to be widely used in B 5G to 6G wireless network deployment scenario to improve network coverage and system capacity, while ensuring service quality for user and improving network spectrum utilization.

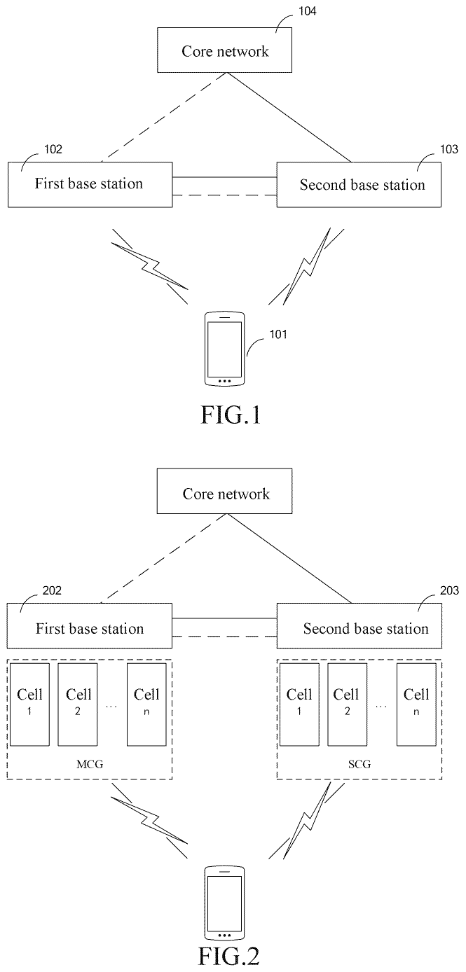

The so-called dual connectivity means that a terminal may be connected to two base stations at the same time. As shown in FIG. 1, a terminal 101 is connected to a first base station 102 and a second base station 103 respectively, and each of the first base station 102 and the second base station 103 is connected to a core network 104. The first base station 102 and the second base station 103 may be of the same type, or may be of different types and are thus called an MR-DC or an NR-DC.

As an example, the first base station 102 and the second base station 103 may both be 5G base stations.

As another example, the first base station 102 may be a 4G base station, and the second base station 103 may be the 5G base station.

In some embodiments, the first base station 102 may be a master node (MN), and the second base station 102 may be a secondary node (SN).

When the terminal 101 intends to access the Internet, it first accesses to the master node, and then adds the secondary node as needed. The master node, also called “anchor point”, is responsible for interacting with a control plane of the core network.

As shown in FIG. 2, each of the master and secondary nodes can also support carrier aggregation for multiple carriers therein.

For the master node, a plurality of cells within the first base station 202 are referred to as a master cell group (MCG).

Correspondingly, a plurality of cells within the second base station 203 of the secondary node are referred to as a secondary cell group (SCG).

For the MCG, similar to ordinary carrier aggregation, a primary cell thereof is also referred to as Pcell, and a secondary cell thereof is also referred to as Scell.

For the SCG, a primary cell thereof is referred to as a primary secondary cell (PSCell), and the remaining ordinary secondary cell thereof is still referred to as a secondary cell (SCells).

The 3GPP has been investigating mobility robustness optimization (MRO) solutions for NR systems since R16, so as to avoid unnecessary handover, improve handover accuracy and robustness, and optimizing network mobility performance.

The inventors have found that the MRO solutions have been designed for cell handover and PSCell change failure scenarios, and optimized for near-radio link failure (near-RLF) scenarios that occur in the successful handover scenario. However, in the relevant solutions, the network may not obtain relevant information about a near-failure scenario (e.g., a T310 timer has run to 80% or even more than 90%) during a PSCell change, and thus may not optimize for this type of scenario, which results in the possibility of more serious radio link failure or SCG connection failure at the terminal.

It is to be noted that embodiments of the present disclosure are applicable to MRDC scenarios, and the MRDC scenarios may include ENDC, NRDC, and NGEN-DC.

Embodiments of the present disclosure are directed to a scenario in which PSCell changes, which may include conventional PSCell addition, conditional PSCell addition, conventional PSCell change and conditional PSCell change, and the PSCell change scenario is further divided into MN-initiated PSCell change and SN-initiated PSCell change.

The PSCell change scenario may also be divided into intra-SN PSCell change and inter-SN PSCell change.

The T310 timer is defined in the relevant standards as follows.

The UE starts the T310 timer when the underlying layer receives N310 consecutive “out-of-sync” indications for the PSCell (NR). If the UE receives N311 In-Sync indications before T310 expires, the timer is terminated. Otherwise, the UE triggers radio link failure (RLF) when the timer expires. It can be seen that the T310 timer may reflect a connection state of the terminal and the SCG, and if the T310 timer on the terminal side is about to expire (e.g., it has already run to 90% or more of a preset duration), it indicates that it is about to trigger an SCG failure, i.e., the “near-failure scenario” described in the present disclosure.

Based on this, an embodiment of the present disclosure provides a PSCell change optimization solution, so that the network may timely obtain necessary information recorded on the terminal side under the PSCell change near failure scenario, analyze, based on such information, the reason that potentially leads to the radio link failure, and then optimize the configuration parameter related to the PSCell change procedure, thereby improving the success rate of the PSCell change, and improving the robustness of the network.

It is to be noted that the terminal in the embodiments of the present disclosure includes, but is not limited to, a mobile phone, tablet, laptop, in-vehicle communication device, drone, communication module on the drone, remotely piloted aircraft, aerial vehicle, small aircraft, transport vehicle, vehicle, RSU, wireless sensor, internet access card, internet of things terminal, RFID terminal, NB-IOT terminal, machine type communication (MTC) terminal, enhanced MTC (eMTC) terminal, data card, internet access card, in-vehicle communication device, low-cost mobile phone, low-cost tablet, and other wireless communication devices.

The “base station” such as the first base station and the second base station in the embodiments of the present disclosure include, but is not limited to, a macro cellular base station, a micro cellular base station, a small cellular base station, a home base station, a relay base station, an eNB, a gNB, a transmitter receiver point (TRP), a GNSS, a relay satellite, a satellite base station, an aerial base station, a road side unit (RSU), a UAV, a test equipment, and a wireless communication device such as a transceiver device or signaling tester simulating some functions of a base station.

The example implementation is described in detail below in conjunction with the accompanying drawings and embodiments.

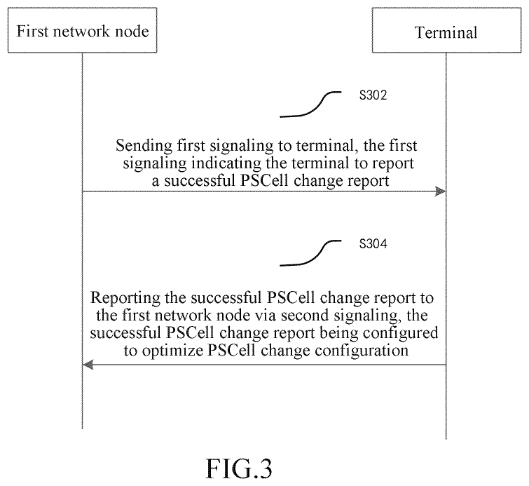

FIG. 3 illustrates a flowchart of a PSCell change optimization method in an embodiment of the present disclosure. As shown in FIG. 3, the PSCell change optimization method provided in an embodiment of the present disclosure includes steps S302-S304.

In S302, a first network node sends first signaling to a terminal, the first signaling indicating the terminal to report a successful PSCell change report.

Here, the first network node may be a base station connected to the terminal.

As an example, the first network node may be a master node in the dual connectivity technology.

In some embodiments, the successful PSCell change report may include at least one of:
a source PSCell identification (ID), a measurement report of a source PSCell (e.g., a latest measurement report of the source PSCell), a target PSCell ID, a measurement report of a target PSCell (e.g., a latest measurement report of the target PSCell), a candidate PSCell ID, a measurement report of a candidate PSCell (e.g., a latest measurement report corresponding to the candidate PSCell), a measurement report of a neighboring cell (e.g., a latest measurement report of the neighboring cell), terminal location information, conditional PScell change (CPC) indication, conditional PSCell addition (CPA) indication, a time interval from UE successful reception of CPC configuration to triggered execution of CPC (TimeSinceCPCconfiguration), a time interval from UE successful reception of CPA configuration to triggered execution of CPA (TimeSinceCPAconfiguration), or user plane data interruption time (UPDataInterruption Time).

The CPC indication indicates that the successful PSCell change report corresponds to a conditional PSCell change procedure, and the CPA indication indicates that the successful PSCell change report corresponds to a conditional PSCell addition procedure.

The successful PSCell change report carries information related to secondary node addition.

In S304, the terminal reports the successful PSCell change report to the first network node via second signaling, the successful PSCell change report being configured to optimize PSCell change configuration.

In some embodiments, the first network node may initially analyze the successful PSCell change report to identify a source node that triggers a PSCell change procedure of the successful PSCell change report.

Here, the source node may be the first network node or a second network node.

After the first network node receives the report reported by the terminal, it first performs an initial analysis to identify the source node that triggers the PSCell change procedure corresponding to the report. If the procedure is triggered by the first network node, the first network node further performs an in-depth root-cause analysis to identify the reason that potentially leads to a near-failure event, and then optimize network configuration parameter, thereby improving the network robustness. If the first network node after performing the initial analysis identifies that the trigger node corresponding to the PSCell change procedure is the second network node, the first network node forwards the report to the second network node via third signaling and the second network node performs the root-cause analysis and optimizes the configuration.

That is, when the source node is the second network node, the first network node also forwards, via the third signaling, the successful PSCell change report to the second network node.

In some embodiments, the first network node may be a master node (MN), and the second network node may be a secondary node (SN).

In the above embodiments, the source node optimizes the PSCell change configuration based on the successful PSCell change report.

In some embodiments, the successful PSCell change report also carries information measured and recorded by the UE regarding the secondary node addition. That is to say, the embodiment of the present disclosure is also applicable to the secondary node addition, i.e., the SCG addition/PSCell addition procedure, and may be applied to both ordinary PSCell addition and conditional PSCell addition. It can be understood that the secondary node addition (i.e., the PSCell addition) is a special case of the PSCell change. The above successful PSCell change report may carry some information measured and recorded by the terminal during the secondary node addition procedure, and is reported on demand by the terminal based on the indication of the first network node and the type of procedure performed by the terminal. In the above embodiment, optimizing the PSCell change configuration may include at least one of:
adjusting a condition configuration for triggering a PSCell addition or change; adjusting an event configuration for triggering the PSCell addition or change; or adjusting a threshold of a triggering event.

That is, the condition and/or event configuration for triggering the PSCell change may be appropriately adjusted, the threshold of the triggering event may be appropriately adjusted up or down, or the like.

In the embodiment of the present disclosure, the processes of information reporting of the UE and information transferring between nodes are enhanced, so that in the case of the PSCell change near-failure, the terminal records and stores relevant information and reports the same to the network, to help the network to analyze improper aspects of the configuration and adjust the same in a timely manner, thereby optimizing the system configuration.

It is to be noted that in an embodiment of the present disclosure, the first signaling and the second signaling may be RRC signaling, and the third signaling may be Xn/X2 interface signaling.

In an example, the first signaling is RRC signaling (NW→UE), which may be UEInformationRequest signaling.

In an example, the second signaling is RRC signaling (UE→NW), which may be UEInformationReponse signaling.

In an example, the third signaling is at least one of Access and mobility indication signaling, SN/SgNB Modification Request signaling, new Xn/X2 signaling.

If the source node is of a split architecture, the successful PSCell change report is communicated between a centralized unit (CU) and a distributed unit (DU) of the source node via Access and mobility indication signaling via an F1 interface. Further, the DU of the source node can optimize PSCell change/addition related parameters based on the received successful PSCell change report. In an embodiment, the source node may be a gNB.

That is, if the first network node or the second network node is a CU/DU split architecture, the PSCell change report may also be communicated via the F1 interface, and in an embodiment, the report is communicated using Access and mobility indication signaling via the F1 interface.

In some embodiments, the successful PSCell change report may be included in other UE reporting information such as successful handover report.

In embodiments of the present disclosure, the terms “first”, “second”, and “third” are used for descriptive purposes only and are not to be construed as indicating or implying relative importance.

The term “and/or” in the present disclosure is merely a description of an associated relationship of associated objects, indicating that three kinds of relationships may exist, for example, A and/or B may indicate the existence of A alone, the existence of both A and B, and the existence of B alone. In addition, the character “/” in the present disclosure generally indicates that the associated objects before and after the same are in an “or” relationship.

The following is a detailed description of the embodiments of the present disclosure in combination with specific application scenarios.

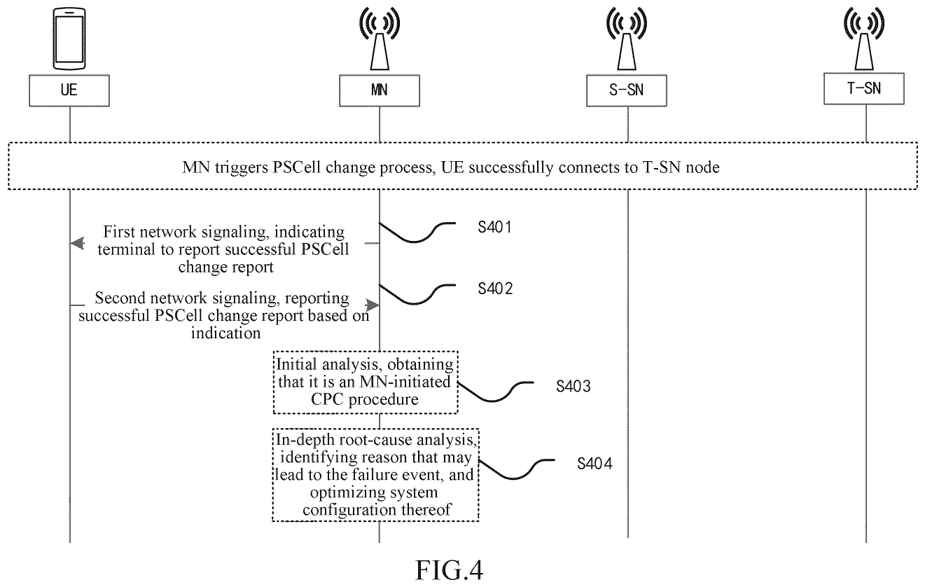

FIG. 4 illustrates a flowchart of a PSCell change optimization method in an embodiment of the present disclosure. As shown in FIG. 4, in a PSCell change scenario triggered by an MN in an MRDC scenario, the method includes steps S401-S404.

In S401, the MN indicates a terminal to report a successful PSCell change report via first network signaling.

In S402, the UE reports the successful PSCell change report via second network signaling.

In S403, the MN obtains that it is an MN-initiated CPC procedure by performing an initial analysis based on the successful PSCell change report.

In S404, the MN identifies the reason that may lead to the failure event by performing an in-depth root-cause analysis, and optimizes the system configuration thereof.

Here, the first network node is the MN, the second network node is the SN, and the MN performs the cause analysis and adjusts the parameter to optimize the same.

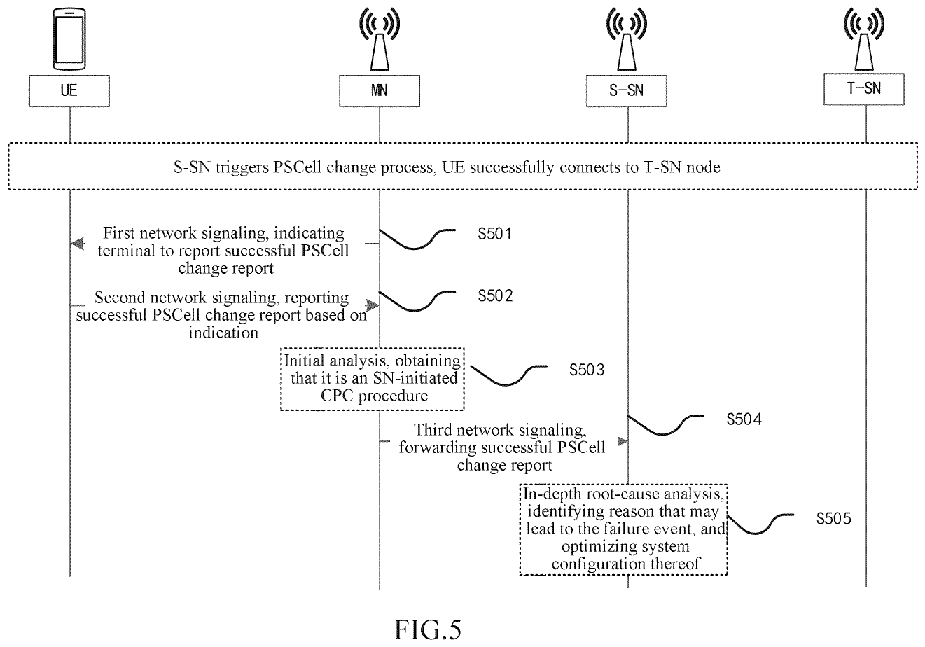

FIG. 5 illustrates a flowchart of a PSCell change optimization method in an embodiment of the present disclosure. As shown in FIG. 5, in an SN-triggered PSCell change scenario under an MRDC scenario, the method includes steps S501-S505.

In S501, the MN indicates a terminal to report a successful PSCell change report via first network signaling.

In S502, the UE reports the successful PSCell change report via second network signaling.

In S503, the MN obtains that it is an SN-initiated CPC procedure by performing an initial analysis based on the successful PSCell change report.

In S504, the MN forwards the successful PSCell change report to the S-SN via third network signaling.

In S505, the SN identifies the reason that may lead to the failure event by performing an in-depth root-cause analysis, and optimizes the system configuration thereof.

Here, the first network node is the MN, the second network node is the SN, and the source SN performs the cause analysis and adjusts the parameter to optimize the same.

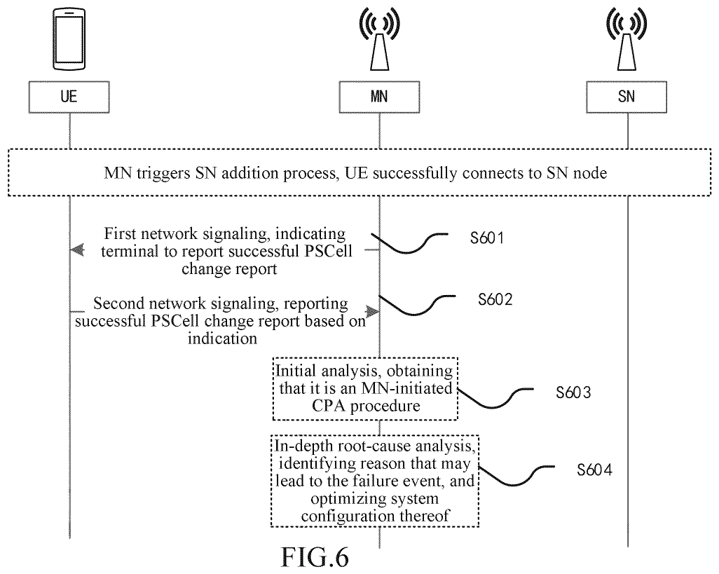

FIG. 6 illustrates a flowchart of a PSCell change optimization method in an embodiment of the present disclosure. As shown in FIG. 6, in an SN/SCG/PSCell addition scenario, a source base station triggers a secondary node addition procedure, and after the addition is completed, the system is in a dual-connection architecture, and the source base station becomes an MN, which performs the cause analysis and adjusts and optimizes the parameter. Steps S601-S604 in the method are similar to the above steps S401-S404, but the successful PSCell change report also carries information measured and recorded by the UE for the secondary node addition.

The embodiment of the present disclosure may be well compatible with existing protocol procedures, and may help the network to perform cause analysis and optimize network configuration parameters for the PSCell change near-failure scenario, thereby improving the robustness of the PSCell Change procedure.

Furthermore, although the various steps of the method in the present disclosure are described in the accompanying figures in a particular order, it is not required or implied that the steps must be performed in that particular order or that all of the steps shown must be performed to achieve the desired result.

In some embodiments, certain steps may be omitted, multiple steps may be combined to be performed as a single step, and/or a single step may be broken down to be performed as multiple steps, or the like.

With the development of millimeter wave technology or the like, the MR-DC architecture is to be widely used in practical deployment scenarios for B5G to 6G wireless networks, and for application scenarios with high reliability requirements, it is necessary to support a self-optimizing mechanism for network parameters. The embodiment of the present disclosure optimizes the existing PSCell change procedure, which can effectively reduce the probability of SCG failure (the SCG failure affects the handover success rate, resulting in traffic pitfall phenomenon and having a serious impact on the user rate experience in the mobile situation). A step in the solution provided by the present disclosure (such as cause analysis and configuration and optimization of system parameter performed by the network and other steps) may be well integrated with an AI/ML technology, which has backward compatibility in the wireless network evolution process, and is in line with the intelligent evolution of the wireless network.

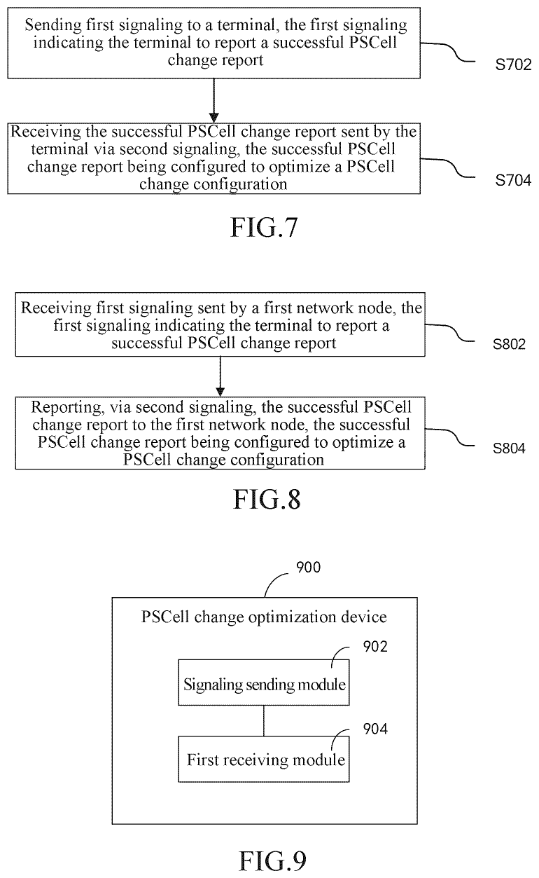

Based on the same inventive conception, an embodiment of the present disclosure also provides a PSCell change optimization method applied to a first network node, and as shown in FIG. 7, the PSCell change optimization method includes:

S702, sending first signaling to a terminal, the first signaling indicating the terminal to report a successful PSCell change report; and S704, receiving the successful PSCell change report sent by the terminal via second signaling, the successful PSCell change report being configured to optimize a PSCell change configuration.

In the PSCell change optimization method provided by the embodiment of the present disclosure, the first network node indicates the terminal to report the successful PSCell change report, and then analyzes the successful PSCell change report to optimize the PSCell change configuration, which can enhance the MRO effect in the PSCell change scenario, and avoid serious network events such as radio link failure (RLF) or SCG connection failure.

Based on the same inventive concept, an embodiment of the present disclosure also provides a PSCell change optimization method applied to a terminal, and as shown in FIG. 8, the PSCell change optimization method includes:

S802, receiving first signaling sent by a first network node, the first signaling indicating the terminal to report a successful PSCell change report; and

S804, sending, via second signaling, the successful PSCell change report to the first network node, the successful PSCell change report being configured to optimize a PSCell change configuration.

In the PSCell change optimization method provided by the embodiment of the present disclosure, the first network node indicates the terminal to report the successful PSCell change report, and then analyzes the successful PSCell change report to optimize the PSCell change configuration, which can enhance the MRO effect in the PSCell change scenario, and avoid serious network events such as radio link failure (RLF) or SCG connection failure.

Based on the same inventive concept, an embodiment of the present disclosure also provides a PSCell change optimization device, as described in the following embodiments. Since the problem-solving principle in the device embodiment is similar to that in the method embodiment described above, the implementation of the device embodiment can refer to that of the method embodiment described above, which is not repeated herein.

FIG. 9 illustrates a PSCell change optimization device in an embodiment of the present disclosure, which is applied to a first network node, and as shown in FIG. 9, the PSCell change optimization device 900 includes a signaling sending module 902 and a first receiving module 904.

The signaling sending module 902 is configured to send first signaling to a terminal, the first signaling indicating the terminal to report a successful PSCell change report.

The first receiving module 904 is configured to receive the successful PSCell change report sent by the terminal via second signaling, the successful PSCell change report being configured to optimize a PSCell change configuration.

In some embodiments, the PSCell change optimization device 900 may further include a first analyzing module.

The first analyzing module is configured to identify, by initially analyzing the successful PSCell change report, a source node that triggers a PSCell change procedure corresponding to the successful PSCell change report, so that the source node optimizes the PSCell change configuration based on the successful PSCell change report.

In some embodiments, the source node is the first network node or a second network node, and when the source node is the second network node, the PSCell change optimization device 900 may further include a first sending module.

The first sending module is configured to forward the successful PSCell change report to the second network node via third signaling.

In some embodiments, the first network node is a master node (MN), and the second network node is a secondary node (SN).

In some embodiments, the successful PSCell change report further carries information measured and recorded by the terminal for secondary node addition.

In some embodiments, optimizing the PSCell addition or change configuration based on the successful PSCell change report includes at least one of:

adjusting a condition configuration for triggering a PSCell addition or change; adjusting an event configuration for triggering the PSCell addition or change; or adjusting a threshold of a triggering event.

In some embodiments, the successful PSCell change report includes at least one of:
a source PSCell identification (ID), a latest measurement report of a source PSCell, a target PSCell ID, a latest measurement report of a target PSCell, a candidate PSCell ID, a latest measurement report corresponding to a candidate PSCell, a latest measurement report of a neighboring cell, terminal location information, CPC indication, CPA indication, a time interval from UE successful reception of CPC configuration to triggered execution of CPC, a time interval from UE successful reception of CPA configuration to triggered execution of CPA, or user plane data interruption time.

The CPC indication indicates that the successful PSCell change report corresponds to a conditional PSCell change procedure, and the CPA indication indicates that the successful PSCell change report corresponds to a conditional PSCell addition procedure.

In some embodiments, the first signaling and the second signaling are RRC signaling, and the third signaling is Xn/X2 interface signaling.

In some embodiments, the first signaling is UEInformationRequest signaling.

In some embodiments, the second signaling is UEInformationReponse signaling.

In some embodiments, the third signaling is at least one of Access and mobility indication signaling, SN/SgNB Modification Request signaling, or new Xn/X2 signaling.

In some embodiments, if the target network node is of a split architecture, and the successful PSCell change report is communicated between a centralized unit (CU) and a distributed unit (DU) of the target network node via Access and mobility indication signaling via an F1 interface.

The terms such as “first” and “second” mentioned in the present disclosure are only used to differentiate different devices, modules or units, and are not intended to define the order or interdependence of functions performed by these devices, modules or units.

With respect to the PSCell change optimization device in the above embodiment, the specific manner in which each module performs an operation has been described in detail in the embodiment relating to the PSCell change optimization method, and will not be described in detail herein.

In view of the above, in the PSCell change optimization device provided by the embodiment of the present disclosure, the first network node indicates the terminal to report the successful PSCell change report, and then analyzes the successful PSCell change report to optimize the PSCell change configuration, which can enhance the MRO effect in the PSCell change scenario, and avoid serious network events such as radio link failure (RLF) or SCG connection failure.

It is to be noted that although a number of modules or units of the device for action execution are mentioned in the detailed description above, such division is not mandatory.

Actually, according to the implementation of the present disclosure, the features and functions of two or more modules or units described above may be specified in a single module or unit. Conversely, the feature and function of one module or unit described above may be further divided to be specified by a plurality of modules or units.

Some of the block diagrams shown in the accompanying figures are functional entities that do not necessarily have to correspond to physically or logically separate entities. These functional entities may be implemented in software form, or in one or more hardware modules or integrated circuits, or in different networks and/or processor devices and/or microcontroller devices.

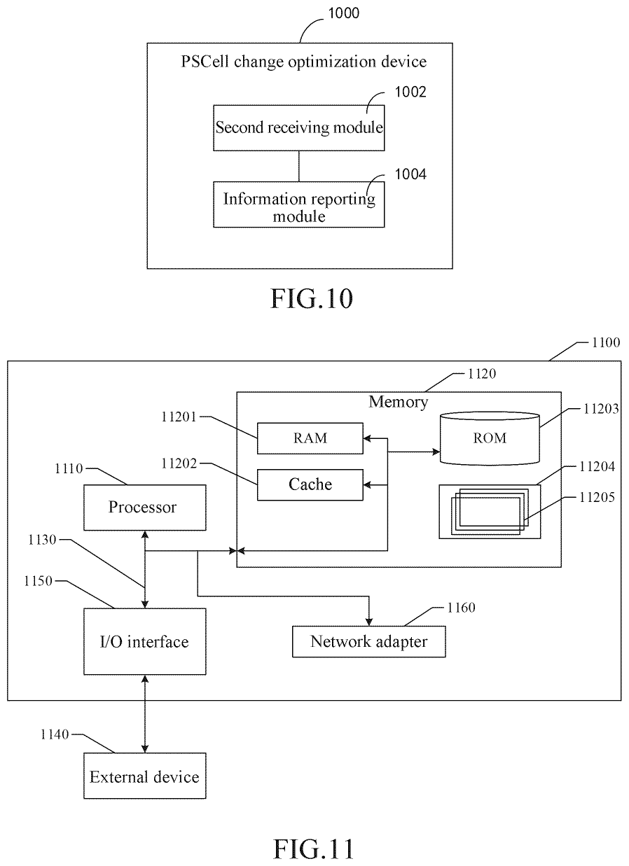

Based on the same inventive concept, an embodiment of the present disclosure also provides a PSCell change optimization device applied to a terminal, and as shown in FIG. 10, the PSCell change optimization device 1000 includes a second receiving module 1002 and an information reporting module 1004.

The second receiving module 1002 is configured to receive first signaling sent by a first network node, the first signaling indicating the terminal to report a successful PSCell change report.

The information reporting module 1004 is configured to send, via second signaling, the successful PSCell change report to the first network node, the successful PSCell change report being configured to optimize a PSCell change configuration.

With respect to the PSCell change optimization device in the above embodiment, the specific manner in which each of the modules performs an operation has been described in detail in the embodiments relating to the PSCell change optimization method, and will not be described in detail herein.

An electronic device provided by an embodiment of the present disclosure is described below with reference to FIG. 11. The electronic device 1100 shown in FIG. 11 is merely an example and should not impose any limitation on the function and use scope of the embodiments of the present disclosure.

FIG. 11 illustrates a schematic diagram of an architecture of an electronic device 1100 provided by an embodiment of the present disclosure. As shown in FIG. 11, the electronic device 1100 includes, but is not limited to, at least one processor 1110 and at least one memory 1120.

The memory 1120 stores instructions.

In some embodiments, the memory 1120 may include a readable medium in the form of a volatile storage unit, such as a random access memory unit (RAM) 11201 and/or a cache unit 11202, and may further include a read-only storage unit (ROM) 11203.

In some embodiments, the memory 1120 may also include a program/utility tool 11204 having a set (at least one) of program modules 11205, and such program module 11205 may include, but not limited to: an operating system, one or more applications, other program modules, and program data, and each of these examples or some combination thereof may include an implementation of a network environment.

In some embodiments, the memory 1120 may store an operating system. The operating system may be an operating system such as Real Time executive (RTX), LINUX, UNIX, WINDOWS, or OS X.

In some embodiments, the memory 1120 may also store data.

As an example, the processor 1110 may read data stored in the memory 1120, which may be stored at the same storage address as the instructions or at a different storage address than the instructions.

The processor 1110 is configured to invoke the instructions stored in the memory 1120 to implements the steps described in the above-described method section of this specification according to various implementations of the present disclosure. For example, the processor 1110 may perform the following steps in the method embodiments described above:
sending first signaling to a terminal, the first signaling indicating the terminal to report a successful PSCell change report; and
receiving the successful PSCell change report sent by the terminal via second signaling, the successful PSCell change report being configured to optimize a PSCell change configuration.

Alternatively, the processor 1110 may perform the following steps in the method embodiments described above:
receiving first signaling sent by a first network node, the first signaling indicating the terminal to report a successful PSCell change report; and
sending, via second signaling, the successful PSCell change report to the first network node, the successful PSCell change report being configured to optimize a PSCell change configuration.

It is to be noted that the above processor 1110 may be a general purpose processor or a dedicated processor. The processor 1110 may include one or more processing cores, and the processor 1110 performs various functional applications and processes data by running the instructions.

In some embodiments, the processor 1110 may include a central processing unit (CPU) and/or a baseband processor.

In some embodiments, the processor 1110 may determine an instruction based on a priority identifier and/or functional class information carried in the respective control instruction.

In the present disclosure, the processor 1110 and the memory 1120 may be provided separately or may be integrated together.

As an example, the processor 1110 and the memory 1120 may be integrated on a single board or a system on chip (SOC).

As shown in FIG. 11, the electronic device 1100 is represented in the form of a general purpose computing device. The electronic device 1100 may also include a bus 1130.

The bus 1130 may represent one or more of several types of bus structures, including a memory unit bus or memory unit controller, a peripheral bus, a graphics acceleration port, a processor, or a local area bus using any of a variety of bus structures.

The electronic device 1100 may also be in communication with one or more external devices 1140 (e.g., a keyboard, a pointing device, a Bluetooth device, etc.), and may also be in communication with one or more devices that enable a user to interact with the electronic device 1100, and/or may be in communication with any device (e.g., a router, a modem, etc.) that enables the electronic device 1100 to communicate with one or more other computing devices. Such communication may be carried out via the input/output (I/O) interface 1150.

Further, the system may also communicate with one or more networks (e.g., a local area network (LAN), a wide area network (WAN), and/or a public network, such as the Internet) via the network adapter 1160.

As shown in FIG. 11, the network adapter 1160 communicates with other modules of the electronic device 1100 via the bus 1130.

It is to be noted that although not shown in the figures, other hardware and/or software modules may be used in conjunction with the electronic device 1100, including, but not limited to: microcode, device drives, redundant processing units, external disk drive arrays, RAID systems, tape drives, data backup storage system or the like.

It is to be understood that the structures illustrated by the embodiments of the present disclosure do not constitute a specific limitation of the electronic device 1100. In other embodiments of the present disclosure, the electronic device 1100 may include more or fewer components than that shown in FIG. 11, or a combination of certain components, or a splitting of certain components, or a different arrangement of components. The component shown in FIG. 11 may be implemented in hardware, software, or a combination of software and hardware.

The present disclosure also provides a computer-readable storage medium having computer instructions stored thereon that, when being executed by a processor, implement the PSCell change optimization method described in the method embodiments above.

In an embodiment of the present disclosure, the computer-readable storage medium may send, communicate or transmit a computer instruction for use by, or in combination with, an instruction-executing system, apparatus, or device.

As an example, the computer-readable storage medium is a non-volatile storage medium.

In some embodiments, more specific examples of computer readable storage media in the present disclosure include, but not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, a USB flash drive, a portable hard drive, or any suitable combination thereof.

In an embodiment of the present disclosure, the computer-readable storage medium may include a data signal propagated in a baseband or as part of a carrier in which computer instructions (readable program codes) are carried.

Such propagated data signals may take a variety of forms, including, but not limited to, electromagnetic signals, optical signals, or any suitable combination thereof.

The readable signal medium may also be any readable medium other than the readable storage medium.

In some examples, the computer instructions contained on the computer readable storage medium may be transmitted using any suitable medium, including, but not limited to: wireless, wire, optical cable, RF, or the like, or any suitable combination thereof.

An embodiment of the present disclosure also provides a computer program product storing instructions that, when being executed by a computer, cause the computer to implement the PSCell change optimization method described in the method embodiment above.

The above instructions may be program codes. In a particular implementation, the program codes may be written by any combination of one or more programming languages.

The programming languages include object-oriented programming languages—such as Java, C++—and conventional procedural programming languages—such as the ‘C’ language or similar programming languages.

The program codes may be executed entirely on a user computing device, executed partially on the user device, executed as a stand-alone software package, executed partially on the user computing device and partially on a remote computing device, or executed entirely on a remote computing device or server.

In the case of the remote computing device, the remote computing may be connected to the user computing device via any kind of network, including a local area network (LAN) or a wide area network (WAN), or may be connected to an external computing device (e.g., by using the Internet of an Internet service provider).

An embodiment of the present disclosure also provides a chip including at least one processor and an interface.

The interface provides program instructions or data to the at least one processor.

The at least one processor executes the program instructions to implement the PSCell change optimization method described in the method embodiments above.

In some embodiments, the chip may further include a memory for storing the program instructions and data, and the memory is provided within or outside the processor.

A person skilled in the art will appreciate that all or some of the steps of the above embodiments may be realized in the form of a complete hardware implementation, a complete software implementation (including firmware, microcode, etc.), or a combination implementation of hardware and software aspects, which may be collectively referred to herein as a “circuit”, “module” or “system”.

A person skilled in the art may easily conceive of other embodiments of the present disclosure upon consideration of the specification and practice of the invention disclosed herein.

The present disclosure is intended to cover any variations, uses, or adaptations of the present disclosure that follow the general principles of the present disclosure and include the common knowledge or customary technical means in the art not disclosed by the present disclosure. The specification and embodiments are to be regarded as exemplary only, and the true scope of the present disclosure is indicated by the claims.

1. A primary secondary cell (PSCell) change optimization method applied to a first network node, comprising:
sending first signaling to a user equipment (UE), the first signaling indicating the UE to report a successful PSCell change report; and
receiving the successful PSCell change report sent by the UE via second signaling, the successful PSCell change report being configured to optimize a PSCell change configuration,
wherein the successful PSCell change report comprises at least one of: a source PSCell identification (ID), a measurement report of a source PSCell, a target PSCell ID, a measurement report of a target PSCell, a candidate PSCell ID, a measurement report of a candidate PSCell, a measurement report of a neighboring cell, UE location information, CPC indication, CPA indication, TimeSinceCPCconfiguration, TimeSinceCPAconfiguration, or UPDataInterruption Time.

2. The method according to claim 1, further comprising: performing initial analysis based on the received successful PSCell change report, and deducing a source node that triggers a PSCell change procedure corresponding to the successful PSCell change report, then the source node can optimize the PSCell change configuration based on the successful PSCell change report.

3. The method according to claim 2, wherein the source node is the first network node or a second network node, and when the source node is the second network node, the method further comprises: forwarding the successful PSCell change report to the second network node via third signaling.

4. The method according to claim 3, wherein the first network node is a master node, and the second network node is a secondary node in multi-RAT dual connectivity scenario.

5. The method according to claim 1, wherein the successful PSCell change report further comprises information related to secondary node addition.

6. The method according to claim 1, wherein optimizing the PSCell change configuration based on the successful PSCell change report comprises at least one of:
adjusting a condition configuration for triggering a PSCell addition or change;
adjusting an event configuration for triggering the PSCell addition or change; or
adjusting a threshold of a triggering event.

7. The method according to claim 1, wherein the CPC indication indicates that the successful PSCell change report corresponds to a conditional PSCell change procedure, and the CPA indication indicates that the successful PSCell change report corresponds to a conditional PSCell addition procedure.

8. The method according to claim 1, wherein the first signaling and the second signaling are RRC signaling, and the third signaling is Xn/X2 interface signaling.

9. The method according to claim 8, wherein the first signaling is UEInformationRequest signaling.

10. The method according to claim 8, wherein the second signaling is UEInformationReponse signaling.

11. The method according to claim 8, wherein the third signaling is at least one of Access and mobility indication signaling, SN/SgNB Modification Request signaling, or new Xn/X2 signaling.

12. The method according to claim 2, wherein if a source node is consisted of a centralized unit (CU)/distributed unit (DC) split architecture, the successful PSCell change report is transferred from the (CU)CU (DU)to the DU of the source node via Access and mobility indication signaling via an F1 interface,
the DU of the source node can optimize PSCell change/addition related parameters based on the received successful PSCell change report.

13. A PSCell change optimization method applied to a UE, comprising:
receiving first signaling sent by a first network node, the first signaling indicating the UE to report a successful PSCell change report; and
sending, via second signaling, the successful PSCell change report to the first network node, the successful PSCell change report being configured to optimize a PSCell change configuration,
wherein the successful PSCell change report comprises at least one of:
a source PSCell identification (ID), a measurement report of a source PSCell, a target PSCell ID, a measurement report of a target PSCell, a candidate PSCell ID, a measurement report of a candidate PSCell, a measurement report of a neighboring cell, UE location information, CPC indication, CPA indication, TimeSinceCPCconfiguration, TimeSinceCPAconfiguration, or UPDataInterruption Time.

14-18. (canceled)

19. A primary secondary cell (PSCell) change optimization device applied to a first network node, comprising:
at least one hardware processor; and
a memory having program instructions stored thereon that, when being executed by the at least one hardware processor, cause the first network node to implement actions comprising:
sending first signaling to a UE, the first signaling indicating the UE to report a successful PSCell change report; and
receiving the successful PSCell change report sent by the UE via second signaling, the successful PSCell change report being configured to optimize a PSCell change configuration,
wherein the successful PSCell change report comprises at least one of: a source PSCell identification (ID), a measurement report of a source PSCell, a target PSCell ID, a measurement report of a target PSCell, a candidate PSCell ID, a measurement report of a candidate PSCell, a measurement report of a neighboring cell, UE location information, CPC indication, CPA indication, TimeSinceCPCconfiguration, TimeSinceCPAconfiguration, or UPDataInterruption Time.

20. The device according to claim 19, wherein the actions further comprise:
performing initial analysis based on the received successful PSCell change report, and deducing a source node that triggers a PSCell change procedure corresponding to the successful PSCell change report, then the source node can optimize the PSCell change configuration based on the successful PSCell change report.

21. The device according to claim 20, wherein the source node is the first network node or a second network node, and when the source node is the second network node, the actions further comprise: forwarding the successful PSCell change report to the second network node via third signaling.

22. The device according to device 21, wherein the first network node is a master node, and the second network node is a secondary node in multi-RAT dual connectivity scenario.

23. The device according to claim 19, wherein the successful PSCell change report further comprises information related to secondary node addition.

24. The device according to claim 19, wherein optimizing the PSCell change configuration based on the successful PSCell change report comprises at least one of:
adjusting a condition configuration for triggering a PSCell addition or change;
adjusting an event configuration for triggering the PSCell addition or change; or
adjusting a threshold of a triggering event.

25. A primary secondary cell (PSCell) change optimization device applied to a UE, comprising:
at least one hardware processor; and
a memory having program instructions stored thereon that, when being executed by the at least one hardware processor, cause the UE to implement the method according to claim 13.
